(19) United States
(12) Patent Application Publication
(10) Pub. No.: US 2019/0339207 A1
(43) Pub. Date: Nov. 7, 2019

(54) SYSTEM AND METHOD FOR FLEXIBLY HOLDING WORKPIECE AND REPORTING WORKPIECE LOCATION

(71) Applicant: United Technologies Corporation, Farmington, CT (US)

(72) Inventors: Alan Matthew Finn, Hebron, CT (US); Catalin G. Fotache, West Hartford, CT (US)

(73) Assignee: United Technologies Corporation, Farmington, CT (US)

(21) Appl. No.: 15/971,205

(22) Filed: May 4, 2018

(51) Int. Cl. G01N 21/88; B25B 11/00; B25J 15/06; B25J 19/02

(52) U.S. Cl. CPC G01N 21/8851; B25B 11/005; B25J 15/0616; B25J 19/022; G01N 2201/126; B25J 19/026; B25J 19/027; B25J 19/023; G01N 2201/102; B25J 19/025

(57) ABSTRACT

A vacuum clamp inspection system comprises a rigid structure; a sensor system mounted relative to the rigid structure; a calibration fixture mounted on the table; and a vacuum clamp configured to provide at least one of a location and a pose of a component relative to the calibration fixture.

### BACKGROUND

The present disclosure is directed to a vacuum clamp for an inspection system. Particularly, the disclosure is directed to a vacuum clamp capable of reporting a workpiece location and pose by combining a calibration fixture, vacuum line instrumentation, and image, video, or 3D (depth) analytics to determine the clamp to part orientation.

Gas turbine engine components, such as blades, may suffer wear and damage during operation, for example, due to erosion, hot corrosion (sulfidation), cracks, dents, nicks, gouges, and other damage, such as from foreign object damage. Detecting this damage may be achieved by images or videos for aircraft engine blade inspection, power turbine blade inspection, internal inspection of mechanical devices, and the like. A variety of techniques for inspecting by use of images or videos may include capturing and displaying images or videos to human inspectors for manual defect detection and interpretation. Human inspectors may then decide whether any defect exists within those images or videos. When human inspectors look at many similar images of very similar blades of an engine stage or like components of a device, they may not detect defects, for example, because of fatigue or distraction experienced by the inspector. Missing a defect may lead to customer dissatisfaction, transportation of an expensive engine back to service centers, lost revenue, or even engine failure. Additionally, manual inspection of components may be time consuming.

### SUMMARY

In accordance with the present disclosure, there is provided a vacuum clamp inspection system comprising a rigid structure; a sensor system mounted relative to the rigid structure; a calibration fixture mounted on the rigid structure; and a vacuum clamp configured to provide at least one of a location and a pose of a component relative to the fixture.

In another and alternative embodiment, the vacuum clamp inspection system further comprises a flexible vacuum line coupled to the vacuum clamp; at least one instrument coupled to the flexible vacuum line, wherein the at least one instrument is configured to produce at least one of location data and pose data.

In another and alternative embodiment, the vacuum clamp inspection system further comprises a processor coupled to the sensor system; the processor comprising a tangible, non-transitory memory configured to communicate with the processor, the tangible, non-transitory memory having instructions stored therein that, in response to execution by the processor, cause the processor to perform operations comprising: receiving, by the processor, sensor data for the component from the sensor system; receiving, by the processor, at least one of location data and pose data for the component from the vacuum clamp; aligning, by the processor, the sensor data with an orientation reference from the fixture; determining, by the processor, a component pose and a location based on at least one of the sensor data; the orientation reference from a fiduciary mark, the location and a pose of a component relative to said calibration fixture from said vacuum clamp; and said calibration fixture.

In another and alternative embodiment, the instructions comprise sensor analytics programming.

In another and alternative embodiment, the vacuum clamp inspection system of further comprises determining, by the processor, a feature dissimilarity between the sensor data and a reference model; classifying, by the processor, the feature dissimilarity; and determining, by the processor, a probability that the feature dissimilarity indicates damage to the component.

In another and alternative embodiment, the vacuum clamp inspection system further comprises a fiducial mark coupled to the vacuum clamp configured for determining orientation of the vacuum clamp to the component.

In another and alternative embodiment, the sensor system is configured as at least one of a damage sensor and an orientation sensor.

In another and alternative embodiment, the vacuum clamp is configured to attach to the component at a location that does not obstruct sensing by the sensor system.

In another and alternative embodiment, the flexible vacuum line coupled to the vacuum clamp is configured to allow for the component location and pose to move freely with respect to the sensor system.

In another and alternative embodiment, the at least one instrument coupled to the flexible vacuum line comprises a strain gauge.

In accordance with the present disclosure, there is provided a method for inspection of a component utilizing a vacuum clamp inspection system, comprises providing a rigid structure; mounting a sensor system relative to the rigid structure; mounting a calibration fixture on the rigid structure; positioning the sensor system to capture sensor data of a component; coupling a vacuum clamp to the component; coupling a processor to the sensor system and the fixture, the processor configured to determine, by the processor, a component pose and a location based on at least one of the sensor data; the orientation reference from a fiduciary mark, the location and a pose of a component relative to said calibration fixture from said vacuum clamp; and said calibration fixture.

In another and alternative embodiment, the processor performs operations comprises receiving, by the processor, sensor data for the component from the sensor system; receiving, by the processor, at least one of location data and pose data for the component from the vacuum clamp; aligning, by the processor, the sensor data with an orientation reference from the fixture; determining, by the processor, a component pose and location between the sensor data; the orientation reference from the fixture and location and a pose of a component relative to the fixture from the vacuum clamp and the calibration fixture.

In another and alternative embodiment, the method for inspection of a component utilizing a vacuum clamp inspection system further comprises determining, by the processor, a feature dissimilarity between the sensor data and a reference model; classifying, by the processor, the feature dissimilarity; and determining, by the processor, a probability that the feature dissimilarity indicates damage to the component.

In another and alternative embodiment, the system further comprises attaching at least one fiber optic gyroscope to the vacuum clamp; determining at least one of location data and pose data with the at least one fiber optic gyroscope.

In another and alternative embodiment, the system further comprises coupling a flexible vacuum line to the vacuum clamp; at least one instrument being coupled to the flexible vacuum line and producing at least one of location data and pose data with the at least one instrument.

In another and alternative embodiment, the system further comprises coupling the vacuum clamp to the component at a location that does not obstruct the sensor system.

In another and alternative embodiment, the at least one instrument coupled to the flexible vacuum line comprises at least one strain gauge.

In another and alternative embodiment, the system further comprises orienting the vacuum clamp to the component by use of a fiducial marking on the vacuum clamp.

In another and alternative embodiment, the sensor system is configured as at least one of a damage sensor and an orientation sensor.

Other details of the vacuum clamp inspection system are set forth in the following detailed description and the accompanying drawings wherein like reference numerals depict like elements.

### BRIEF DESCRIPTION OF THE DRAWINGS

FIG. 1 is a schematic diagram of an exemplary inspection system in accordance with various embodiments.

FIG. 2 is a process map of an exemplary inspection system in accordance with various embodiments.

FIG. 3 is a schematic diagram of an exemplary vacuum clamp inspection system.

### DETAILED DESCRIPTION

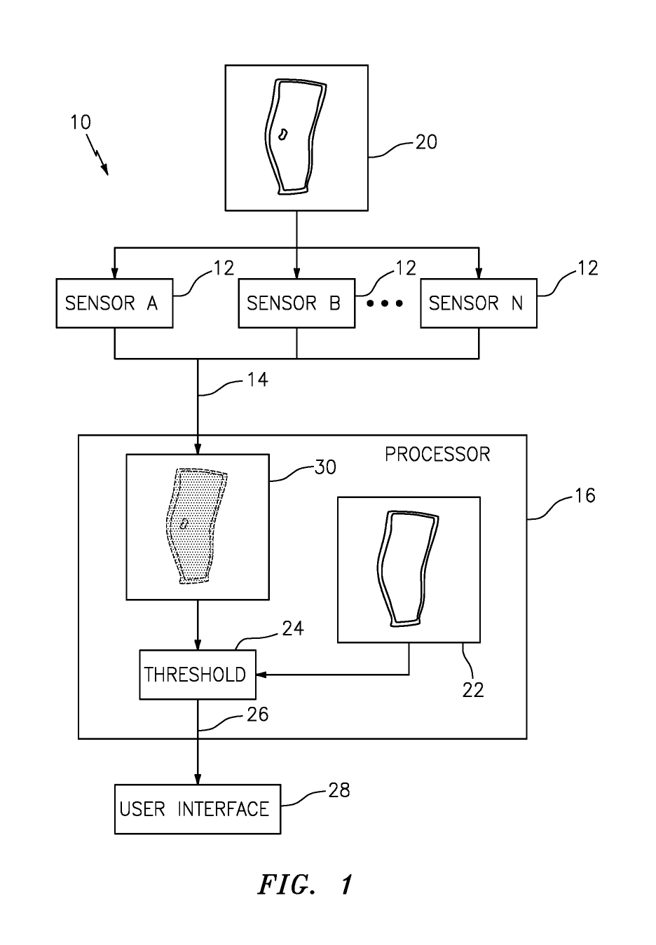

Referring to FIG. 1, a schematic illustration of a vacuum clamp inspection system 10 for detecting a defect or damage to a component 20 is shown, in accordance with various embodiments. The vacuum clamp inspection system 10 may be configured to perform imaging of a component 20. Component 20 may include a component on an aircraft, such as an engine component, such as a blade, a vane, a disk or a gear. Component 20 may be scanned or sensed by one or more sensors 12 to obtain data 14 about the component 20. In various embodiments, data 14 may be obtained by rotating, panning, or positioning the sensor(s) 12 relative to the component 20 to capture data 14 from multiple viewpoint angles, perspectives, and/or depths. Further, the component 20 may be rotated or positioned relative to the sensor(s) 12 to obtain data 14 from multiple viewpoints, perspectives, and/or depths. An array of sensors 12 positioned around component 20 may be used to obtain data 14 from multiple viewpoints. Thus, either of the sensor(s) 12 or component 20 may be moved or positioned relative to the other and relative to various directions or axes of a coordinate system to obtain sensor information from various viewpoints, perspectives, and/or depths. Further, sensor 12 may scan, sense, or capture information from a single position relative to component 20.

In an exemplary embodiment, the sensor 12 can be a camera, and include a one-dimensional (1D), 2D, 3D sensor and/or a combination and/or array thereof. Sensor 12 may be operable in the electromagnetic or acoustic spectrum capable of producing a 3D point cloud, occupancy grid or depth map of the corresponding dimension(s). Sensor 12 may provide various characteristics of the sensed electromagnetic or acoustic spectrum including intensity, spectral characteristics, polarization, and the like. In various embodiments, sensor 12 may include a distance, range, and/or depth sensing device. Various depth sensing sensor technologies and devices include, but are not limited to, a structured light measurement, phase shift measurement, time of flight measurement, stereo triangulation device, sheet of light triangulation device, light field cameras, coded aperture cameras, computational imaging techniques, simultaneous localization and mapping (SLAM), imaging radar, imaging sonar, echolocation, laser radar, scanning light detection and ranging (LIDAR), flash LIDAR, or a combination comprising at least one of the foregoing. Different technologies can include active (transmitting and receiving a signal) or passive (only receiving a signal) and may operate in a band of the electromagnetic or acoustic spectrum such as visual, infrared, ultrasonic, and the like. In various embodiments, sensor 12 may be operable to produce depth from defocus, a focal stack of images, or structure from motion.

In various embodiments, sensor 12 may include an image capture device, such as an optical device having an optical lens, such as a camera, mobile video camera, or other imaging device or image sensor, capable of capturing 2D still images or video images. Sensor 12 may include two or more physically separated cameras that may view a component from different angles, to obtain visual stereo sensor/image data.

In various embodiments, sensor 12 may include a structured light sensor, a line sensor, a linear image sensor, or other 1D sensor. Further, sensor 12 may include a 2D sensor, and optical inspection system 10 may extract 1D information from the 2D sensor data; may include a 1D sensor, and inspection system 10 may synthesize 2D or 3D information from the 1D sensor data; may include a 2D sensor, and inspection system 10 may extract 1D information or synthesize 3D information from the 2D sensor data; may include a 3D sensor, and inspection system 10 may extract 1D or 2D information from the 3D sensor data. The extraction may be achieved by retaining only a subset of the data such as keeping only that data that is in focus. The synthesizing may be achieved by tiling or mosaicking the data. Even further, sensor 12 may include a position and/or orientation sensor such as an inertial measurement unit (IMU) that may provide position and/or orientation information about component 20 with respect to a coordinate system or other sensor 12. The position and/or orientation information may be beneficially employed in aligning 1D, 2D or 3D information to a reference model as discussed elsewhere herein.

Data 14 from sensor(s) 12 may be transmitted to one or more processors 16 (e.g., computer systems having a central processing unit and memory) for recording, processing, and storing the data received from sensors 12. Processor 16 may include a general-purpose processor, a digital signal processor (DSP), an application specific integrated circuit (ASIC), a field programmable gate array (FPGA) or other programmable logic device, discrete gate or transistor logic, discrete hardware components, or any combination thereof. Processor 16 may be in communication (such as electrical communication) with sensors 12 and may be configured to receive input, such as images and/or depth information from sensors 12. Processor 16 may receive data 14 about component 20 captured and transmitted by the sensor(s) 12 via a communication channel. Upon receiving the data 14, the processor 16 may process data 14 from sensors 12 to determine if damage or defects are present on the component 20.

In various embodiments, processor 16 may receive or construct image information 30 corresponding to the component 20. Processor 16 may further include a reference model 22 stored, for example, in memory of processor 16. Reference model 22 may be generated from a CAD model, a 3D CAD model, and/or 3D information, such as from a 3D scan or 3D information of an original component or an undamaged component, and the like. In various alternative embodiments, reference model 22 may comprise 1D or 2D information from a projection of a 2D or 3D model, prior 2D information from sensors 12, and the like. Reference model 22 may be a theoretical model or may be based on historical information about component 20. Reference model 22 may be adjusted and updated as component 20 and/or similar components are scanned and inspected. Thus, reference model 22 may be a learned model of a component and may include, for example, 3D information including shape and surface features of the component.

In various embodiments, processor 16 of inspection system 10 may classify the damage and determine the probability of damage and/or if the damage meets or exceeds a threshold 24. Threshold 24 may be an input parameter based on reference model 22 based on user input, based on data from sensor(s) 12, and the like. Processor 16 may provide an output 26 to a user interface 28 indicating the status of the component 20. User interface 28 may include a display. Inspection system 10 may display an indication of the defect to component 20, which may include an image and/or a report. In addition to reporting any defects in the component, output 26 may also relay information about the type of defect, the location of the defect, size of the defect, and the like. If defects are found in the inspected component 20, an indicator may be displayed on user interface 28 to alert personnel or users of the defect.

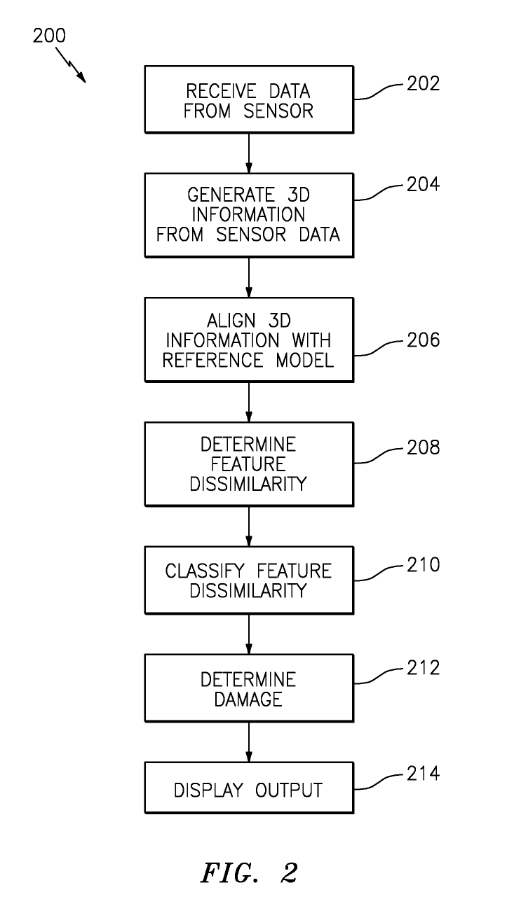

With reference to FIG. 2, a method 200 for detecting defects is provided, in accordance with various embodiments. Processor 16 may be capable of carrying out the steps of FIG. 2. One or more sensor(s) 12 may capture data about a component 20. Method 200, performed by processor 16 of inspection system 10, may include receiving data from a sensor/camera (step 202). Method 200 may include generating 1D, 2D, or 3D information from the sensor data (step 204), e.g., by extracting or synthesizing, as explained elsewhere herein. The 3D information may correspond to the component. Method 200 may include aligning the 3D information with a reference model (step 206), determining a feature dissimilarity between the 3D information and the reference model (step 208), classifying the feature dissimilarity (step 210), determining damage (step 212), and displaying an output (step 214).

Step 202 may further comprise receiving 1D, 2D, and/or 3D data from a sensor 12. In various embodiments, 3D information is received from one or more sensors 12, which may be 3D sensors. In receiving data 14 from a 3D sensor, the inspection system 10 may capture depth points of component 20 and recreate precisely, the actual 3D surfaces of component 20, thereby generating a complete 3D point cloud or a partial 3D point cloud. In an exemplary embodiment, the entire forward surface of a gas turbine engine fan blade can be captured. In another exemplary embodiment, an entire surface of a gas turbine compressor blade can be captured.

Step 204 may comprise producing a 3D point cloud or occupancy grid, a partial 3D point cloud, a model derived from a 3D point cloud, depth map, other depth information, 1D information and/or 2D information. A 3D point cloud or occupancy grid may include a plurality of points or coordinates in a coordinate system having three dimensions, such as an xyz coordinate system or polar coordinate system. A partial 3D point cloud may include a plurality of points or coordinates in a 3D coordinate system, where the sensor data is collected from a single viewpoint or a limited set of viewpoints. A model derived from a 3D point cloud may include a modified 3D point cloud which has been processed to connect various points in the 3D point cloud in order to approximate or functionally estimate the topological surface of the component. A depth map may reflect points from a 3D point cloud that can be seen from a particular viewpoint. A depth map may be created by assuming a particular viewpoint of a 3D point cloud in the coordinate system of the 3D point cloud.

Step 204 may further comprise constructing a complete image or 3D point cloud of the component 20 by tiling, mosaicking, or otherwise combining, e.g., by stereoscopy, structure from motion, simultaneous localization and mapping, and the like, information from multiple sensors 12 or multiple viewpoints. Step 204 may comprise merging data 14 from multiple viewpoints. In various embodiments, step 204 may comprise merging a first data from a 1D sensor and a second data from a 2D sensor and processing the 1D and 2D data to produce 3D information 30.

In various embodiments, step 204 may comprise computing first data from a first 2D sensor and second data from a second 2D sensor. Processor 16 may receive a plurality of 2D sensor data and merge the 2D sensor data to generate a focal stack of 2D sensor data. The focal stack, i.e. multiple layers of 2D sensor data, may produce a volume of data to form the 3D information 30, which may be a 3D representation of the component.

Step 206 may further comprise of aligning the 3D information, such as a 3D point cloud, by an iterative closest point (ICP) algorithm modified to suppress misalignment from damage areas of the component 20. The alignment may be performed by an optimization method, i.e., minimizing an objective function over a dataset, which may include mathematical terms in the ICP objective function or constraints to reject features or damage as outliers. The alignment may be performed by a 3D modification to a random sample consensus (RANSAC) algorithm, scale-invariant feature transform (SIFT), speeded up robust feature (SURF), other suitable alignment method. Step 206 may further include comparing the 3D information 30 to the reference model 22 to align the features from the 3D information 30 with the reference model 22 by identifying affine and/or scale invariant features, diffeomorphic alignment/scale cascaded alignment, and the like. Step 206 may further include registering the features.

Step 208 may further comprise computing features, such as surface and shape characteristics, of the component 20 by methods to identify and extract features. For example, processor 16 may determine differences or dissimilarities between the 3D information 30 and the reference model 22. Step 208 may further comprise identifying features and determining differences or dissimilarities between the identified features in the 3D information 30 and the reference model 22 using a statistical algorithm such as a histogram of oriented gradients in 3D (HoG3D), 3D Zernike moments, or other algorithms. In a HoG3D method, processor 16 may define the orientation of edges and surfaces of 3D information 30 by dividing the 3D information 30 into portions or cells and assigning to each cell a value, where each point or pixel contributes a weighted orientation or gradient to the cell value. By grouping cells and normalizing the cell values, a histogram of the gradients can be produced and used to extract or estimate information about an edge or a surface of the component 20. Thus, the features of the 3D information 30, such as surface and edge shapes, may be identified. Other algorithms, such as 3D Zernike moments, may similarly be used to recognize features in 3D information 30 by using orthogonal moments to reconstruct, for example, surface and edge geometry of component 20. Step 208 may further comprise determining differences or dissimilarities between the identified features in the 3D information 30 and the reference model 22. The dissimilarities may be expressed, for example, by the distance between two points or vectors. Other approaches to expressing dissimilarities may include computing mathematical models of 3D information 30 and reference model 22 in a common basis (comprising modes) and expressing the dissimilarity as a difference of coefficients of the basis functions (modes). Differences or dissimilarities between the 3D information 30 and the reference model 22 may represent various types of damage to component 20.

Step 210 may further comprise classifying the feature dissimilarities identified in step 208. The inspection system 10 may include categories of damage or defect types for component 20. For example, damage may be categorized into classes such as warping, stretching, edge defects, erosion, nicks, cracks, and/or cuts. Step 210 may further comprise identifying the damage type based on the dissimilarities between the 3D information 30 and the reference model 22. Step 210 may further comprise classifying the feature dissimilarities into categories of, for example, systemic damage or localized damage. Systemic damage may include warping or stretching of component 20. Localized damage may include edge defects, erosion, nicks, cracks, or cuts on a surface of component 20. Classifying the feature dissimilarities may be accomplished by, for example, support vector machine (SVM), decision tree, deep neural network, recurrent ensemble learning machine, or other classification method.

Step 212 may further comprise determining whether the feature difference or dissimilarity represents damage to component 20. Step 212 may comprise determining a probability of damage represented by the feature dissimilarity and/or classification. Step 212 may comprise determining damage by comparing the probability of damage to a threshold. Damage may be determined if the probability meets or exceeds a threshold. The inspection system 10 may determine if the damage is acceptable or unacceptable and may determine if the component 20 should be accepted or rejected, wherein a rejected component would indicate that the component should be repaired or replaced.

Step 214 may further comprise transmitting or displaying the 3D information, feature differences or dissimilarities, classification of the feature differences or dissimilarities, a damage report, and/or a determination or recommendation that the component 20 be accepted or rejected. Step 214 may further comprise displaying an image, a 3D model, a combined image and 3D model, a 2D perspective from a 3D model, and the like, of the damaged component for further evaluation by a user or by a subsequent automated system.

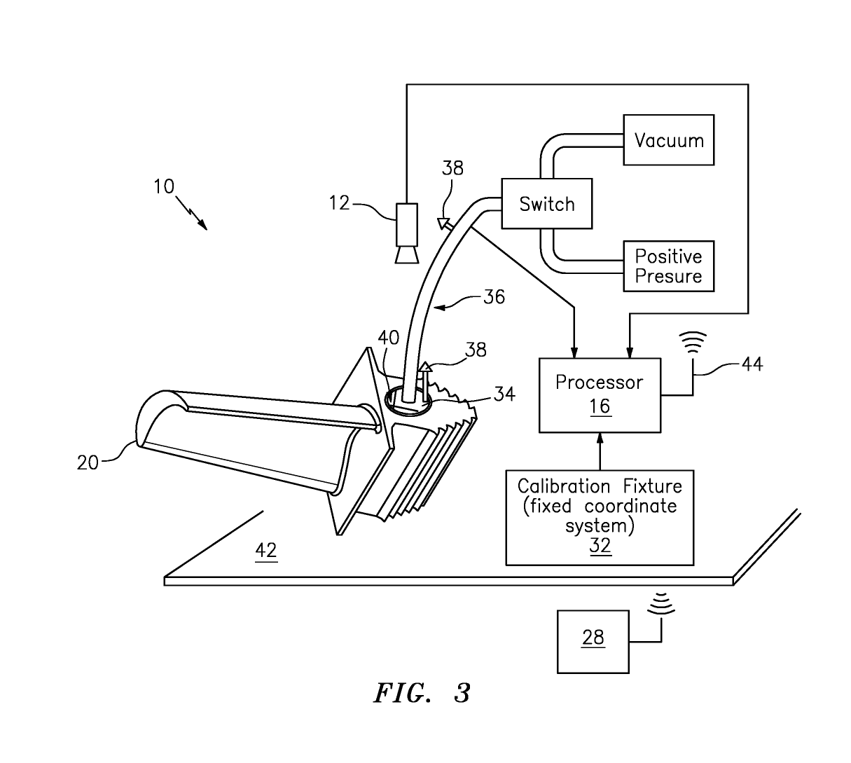

Referring also to FIG. 3 an exemplary vacuum clamp inspection system 10 can be seen. In another exemplary embodiment, the system 10 can include an optical system for a gas turbine engine component inspection. The component 20 can be a disk, a blade, a vane, a gear, and the like. The exemplary embodiment shown in FIG. 3 includes a blade as the component 20. The sensor 12, is shown as an imaging device/sensor system 12 configured to capture images of blade 20 and, optionally, to orient the blade 12 location and pose relative to a vacuum clamp 34. The sensor system 12 can be configured as a damage sensor and/or an orientation sensor. The sensor system 12 can be fixed or mobile, such that the sensor system can move, pan, slide or otherwise reposition to capture the necessary sensor/image data 14 of the blade 20. A vacuum clamp 34 can be coupled to the processor 16. The vacuum clamp 34 is configured to attach to the component 20 by use of a vacuum and seals (not shown) to temporarily couple to the component 20. The vacuum clamp 34 is configured to attach to the component 20 at a location that does not obstruct the sensing by the sensor system 12.

The vacuum clamp 34 can include a vacuum line 36. The vacuum line 36 can be configured to be flexible and allow for the component 20 to move freely both in location and pose with respect to the sensor system 12. The vacuum line 36 can include an instrument 38 coupled to, or integral with, the vacuum line 36. The instrument 38 can be configured to produce at least one of location data and pose data 40 for use in orienting the component 20 with respect to calibration fixture 32. There can be multiple instruments 38 and they may be distributed along vacuum line 36. The instrument 38 can be a strain gauge, such as Fiber Bragg Gratings (FBGs) fabricated along an optical fiber (not shown) where the optical fiber is attached to, or embedded in, vacuum line 36. In an alternative embodiment, the instrument 38 can be attached to the vacuum clamp 34. The instrument 38 can be at least one fiber optic gyroscope. In another embodiment the vacuum clamp 34 can include fiducial marking 40 attached to the vacuum clamp 34 and configured for determining an orientation of the vacuum clamp 34 to the component 20. The fiducial marking 40 can be most helpful in a case when only position of the component 20 is known. In such a case, the orientation of a known fiducial mark 40 on the clamp 34 with respect to the camera 12 may be determined, for example, by an Affine Scale-Invariant Feature Transform (ASFIT) algorithm.

A rigid structure such as a table 42 can be utilized to support the calibration fixture 32. In alternative embodiments, calibration fixture 32 may be supported by a floor, a wall, a ceiling, or any convenient rigid structure.

The location and pose data of the component 20 can be determined through various techniques. A complete set of transformations can be employed for determining the location and pose data for (i) the component 20 to the vacuum clamp 34, (ii) the vacuum clamp 34 to the calibration fixture 32, and (iii) the calibration fixture 32 to the camera 12 data 14. In an exemplary embodiment, the vacuum clamp 34 can be manually affixed to the component 20 in a standard and repeatable way—for instance by careful manual placement, by use of a jig to hold the component 20 and/or vacuum clamp 34, and the like. The necessary transform may then be determined from a priori measurements.

In another exemplary embodiment, the location and orientation of the clamp 34 with respect to the component 20 can be determined (prior to each inspection in case of variations) by registration of the component image 30 to a 3D component model 22, registration of the clamp image 30 to a 3D clamp model 22 (optionally using known fiducial marks 40 as explained elsewhere herein), and by computing the spatial transform using these models.

In another exemplary embodiment, the location and orientation of the clamp 34 to a table 42 position and/or calibration fixture 32 may be determined by Fiber Bragg Gratings (FBGs) fabricated along an optical fiber coupled to the line 36.

Alternatively, the position and orientation may be determined by fiber optic gyroscopes 38 affixed to the clamp 34. The table 42 to camera 12 transform may be determined by any of a number of standard techniques including using manual measurement and manufacturer-supplied camera parameters.

The vacuum clamp inspection system 10 can include a processor 16 coupled to the sensor system 12. The processor 16 can be configured to determine defects or damage to the gas turbine engine blade 20 based on 1D, 2D, or 3D (depth) sensor analytics. The sensor analytics may include 1D or 2D image or video analytics, e.g., morphological filtering, edge detection, segmentation, and the like; may include 3D analytics, e.g., HoG3D, 3D Zernike moments, and the like as described elsewhere herein; and may include classifiers, e.g., SVM, decision trees, deep networks, and the like. The processor 16 is shown with a transceiver 44 configured to communicate wirelessly with the user interface 28. In another exemplary embodiment, the system can be hard wired. The processor 16 can be configured to automatically report damage and archive the damage for trending and condition-based-maintenance.

The processor 16 can be configured to receive the data for the gas turbine engine blade 20 from the sensor system 12. The processor 16 can be configured to image data for the component 20 from the sensor system 12. The processor 16 can be configured to receive at least one of location data and pose data for the component 20 from the vacuum clamp 34 and/or vacuum line 36. The processor 16 can be configured to align the sensor data 14 with an orientation reference from the calibration fixture 32. The processor 16 can be configured to determine a component pose and location between the sensor data 14; the orientation reference from the calibration fixture 32 and location and a pose of the component 20 relative to the calibration fixture 32 from the vacuum clamp 34 and the calibration fixture 32. The processor 16 can be configured to determine a feature dissimilarity between the sensor data 14 and the reference model 22. The processor 16 can be configured to classify the feature dissimilarity. The processor 16 can be configured to determine a probability that the feature dissimilarity indicates damage to the component 20.

There has been provided a vacuum clamp inspection system. While the vacuum clamp inspection system has been described in the context of specific embodiments thereof, other unforeseen alternatives, modifications, and variations may become apparent to those skilled in the art having read the foregoing description. Accordingly, it is intended to embrace those alternatives, modifications, and variations which fall within the broad scope of the appended claims.

What is claimed is:

1. A vacuum clamp inspection system comprising:
a rigid structure;
a sensor system mounted relative to said rigid structure;
a calibration fixture mounted on said rigid structure; and
a vacuum clamp configured to provide at least one of a location and a pose of a component relative to said calibration fixture.

2. The vacuum clamp inspection system of claim 1, further comprising
a flexible vacuum line coupled to said vacuum clamp;
at least one instrument coupled to said flexible vacuum line, wherein said at least one instrument is configured to produce at least one of location data and pose data.

3. The vacuum clamp inspection system of claim 1, further comprising:
a processor coupled to said sensor system; said processor comprising a tangible, non-transitory memory configured to communicate with said processor, the tangible, non-transitory memory having instructions stored therein that, in response to execution by the processor, cause the processor to perform operations comprising:
receiving, by the processor, sensor data for said component from said sensor system;
receiving, by the processor, at least one of location data and pose data for said component from said vacuum clamp;
aligning, by the processor, the sensor data with an orientation reference from said calibration fixture;
determining, by the processor, a component pose and a location based on at least one of the sensor data; the orientation reference from a fiduciary mark, the location and a pose of a component relative to said calibration fixture from said vacuum clamp; and said calibration fixture.

4. The vacuum clamp inspection system of claim 3, wherein said instructions comprise sensor analytics programming.

5. The vacuum clamp inspection system of claim 4, further comprising:
determining, by the processor, a feature dissimilarity between the sensor data and a reference model;
classifying, by the processor, the feature dissimilarity; and
determining, by the processor, a probability that the feature dissimilarity indicates damage to the component.

6. The vacuum clamp inspection system of claim 1, further comprising a fiducial mark coupled to said vacuum clamp and configured for determining orientation of said vacuum clamp to said component.

7. The vacuum clamp inspection system of claim 1, wherein said sensor system is configured as at least one of a damage sensor; an orientation sensor; a camera; a visible spectrum 2D camera, and an industrial microscope with a camera.

8. The vacuum clamp inspection system of claim 1, wherein said vacuum clamp is configured to attach to said component at a location that does not obstruct the sensing by said sensor system.

9. The vacuum clamp inspection system of claim 2, wherein said flexible vacuum line coupled to said vacuum clamp is configured to allow for said component location and pose to move freely with respect to said sensor system.

10. The vacuum clamp inspection system of claim 2, wherein said at least one instrument coupled to said flexible vacuum line comprises a strain gauge.

11. A method for inspection of a component utilizing a vacuum clamp inspection system, comprising:
providing a rigid structure;
mounting a sensor system relative to said rigid structure;
mounting a calibration fixture on said rigid structure;
positioning said sensor system to capture sensor data of a component;
coupling a vacuum clamp to said component;
coupling a processor to said sensor system and said calibration fixture, said processor configured to determine an orientation to said component based on sensor analytics and input from said vacuum clamp.

12. The method for inspection of a component utilizing a vacuum clamp inspection system of claim 11, wherein said processor performs operations comprising:
receiving, by the processor, sensor data for said component from said sensor system;
receiving, by the processor, at least one of location data and pose data for said component from said vacuum clamp;
aligning, by the processor, the sensor data with an orientation reference from said fixture;
determining, by the processor, a component pose and a location based on at least one of the sensor data; the orientation reference from a fiduciary mark, the location and a pose of a component relative to said calibration fixture from said vacuum clamp; and said calibration fixture.

13. The method for inspection of a component utilizing a vacuum clamp inspection system of claim 12, further comprising:
determining, by the processor, a feature dissimilarity between the sensor data and a reference model;
classifying, by the processor, the feature dissimilarity; and
determining, by the processor, a probability that the feature dissimilarity indicates damage to the component.

14. The method for inspection of a component utilizing a vacuum clamp inspection system of claim 12, further comprising:
attaching at least one fiber optic gyroscope to said vacuum clamp;
determining at least one of location data and pose data with said at least one fiber optic gyroscope.

15. The method for inspection of a component utilizing a vacuum clamp inspection system of claim 13, further comprising:
including a flexible vacuum line with said vacuum clamp;
at least one instrument being coupled to said flexible vacuum line, and
producing at least one of location data and pose data with said at least one instrument.

16. The method for inspection of a component utilizing a vacuum clamp inspection system of claim 11 further comprising:
coupling said vacuum clamp to said component at a location that does not obstruct said sensor system.

17. The method for inspection of a component utilizing a vacuum clamp inspection system of claim 15, wherein said at least one instrument coupled to said flexible vacuum line comprises at least one strain gauge.

18. The method for inspection of a component utilizing a vacuum clamp inspection system of claim 12 further comprising:
orienting said vacuum clamp to said component by use of a fiducial marking on said vacuum clamp.

19. The method for inspection of a component utilizing a vacuum clamp inspection system of claim 12, wherein said sensor system is configured as at least one of a damage sensor and an orientation sensor.
